(19) United States
(12) Patent Application Publication
(10) Pub. No.: US 2013/0098658 A1
(43) Pub. Date: Apr. 25, 2013

(54) Electrode Apparatus and Method of Manufacturing Electrodes

(71) Applicant: Neuro Resource Group, Inc., Plano, TX (US)

(72) Inventors: David O. Turner, Royce City, TX (US); Gay L. Byars, Richardson, TX (US); Charles H. Payne, Frisco, TX (US)

(73) Assignee: Neuro Resource Group, Inc., Plano, TX (US)

(21) Appl. No.: 13/656,303

(22) Filed: Oct. 19, 2012

Related U.S. Application Data
(60) Provisional application No. 61/627,863, filed on Oct. 19, 2011.

(51) Int. Cl. H01B 5/00; B25B 11/00; H01R 43/00

(52) U.S. Cl. 174/126.1; 29/884; 29/857; 269/21

(57) ABSTRACT

A method is provided for creating an electrode node array device. First and second conductors are stamped from a stock sheet. Each of the conductors has a plurality of raised protrusions. The protrusions are interleaved in a manner in which in both directions of the array, a raised protrusion of one conductor alternates with a raised protrusion of the other conductor. The method includes assembling the device in stages on a vacuum apparatus having guide pins that interact with guide holes on laminate sheets that are applied to both sides of the first and second conductors.

### RELATED APPLICATIONS AND CLAIM FOR PRIORITY

This application claims the benefit of earlier filed provisional patent application Ser. No. 61/627,863 filed Oct. 19, 2011.

### TECHNICAL FIELD

The disclosure relates generally to a method of manufacturing electrode arrays and, more particularly, to an electrode manufacturing process in which two conductors are simultaneously stamped, the two conductors cooperating to form a plurality of virtual electrode pairs.

### BACKGROUND

Electrode arrays are typically manufactured by a process in which the individual electrodes are created and then placed in an array configuration. This presents a number of problems and inefficiencies. For example, it is inefficient to individually manufacture each electrode in the array. Second, with the array resulting from the prior manufacturing methods, individual wires have to be connected to each electrode in such a manner as to create two circuits. Thus, in a 3×3 electrode array using individual electrodes, for example, nine individual wires are used to complete all required connections.

### SUMMARY

Certain example embodiments provide an apparatus for manufacturing an electrode node array device, a method for making the device and the device itself. In one example embodiment, an electrode node array apparatus is provided. The apparatus includes a first physical electrode element having a first plurality of electrode nodes formed therein interconnected by a common first conductor. The apparatus also includes a second physical electrode element having a second plurality of electrode nodes formed therein interconnected by a common second conductor. The first and second conductors are arranged to interfit the first and second pluralities of electrode nodes to form an array of electrode nodes.

In another example embodiment, a method of making an electrode node array is provided. The method includes providing a conductive sheet and forming a plurality of raised protrusions in the conductive sheet to correspond to a plurality of electrode nodes. The method further includes stamping a first conductor from the conductive sheet, the first conductor having a first set of the plurality of the raised protrusions interconnected by a common first conductor element. The method further includes stamping a second conductor from the conductive sheet, the second conductor having a second set of the plurality of raised protrusions interconnected by a common second conductor element. The method further includes interfitting the first and second conductors so that the first and second sets of raised protrusions are configured in an array of electrode nodes.

In another example embodiment, an apparatus for manufacturing an electrode node array device is provided. The apparatus includes a receiving tray having defined therein a plurality of recesses to correspond with a plurality of electrode nodes of the array device. The apparatus also includes one or more vacuum passages having a first end connectable to a vacuum source and a second end terminating at a hole at a surface of the apparatus. The hole is operable to interact with at least a portion of an array device positioned on the apparatus to hold at least a portion of the array device against the apparatus.

One or more of the embodiments may provide some, none, or all of certain of the following advantages. One advantage is improved reliability by the elimination of numerous wired connections. Another advantage is significant reduction in material and labor costs resulting from reducing part count and elimination of several manufacturing process steps such as, cutting/stripping wire, stamping an electrode which consist of three separate parts which require assembly, and assembling nine individual electrodes.

### BRIEF DESCRIPTION OF THE DRAWINGS

For a more complete understanding of this disclosure and its features, reference is now made to the following description, taken in conjunction with the accompanying drawings, in which:

FIG. 1 is an illustration of a conductive sheet according to an example embodiment;

FIG. 2 is an illustration of an array of raised protrusions on a conductive sheet according to an example embodiment;

FIG. 3 is an illustration of a stamped conductive sheet providing two physical electrode elements according to an example embodiment;

FIG. 4 is an illustration of a stamped conductive sheet with attached electrical leads according to an example embodiment;

FIG. 5 is a perspective view of a stamped conductive sheet with attached electrical leads being coupled to two laminate insulator sheets according to an example embodiment;

FIG. 6 is an electrode array device according to an example embodiment;

FIG. 7 is a perspective view illustrating an apparatus for manufacturing an electrode array device and a stamped conductive sheet providing two physical electrode elements, and further illustrating a step in the manufacturing process according to an example embodiment;

FIG. 8 is a perspective view illustrating an apparatus for manufacturing an electrode array device and a first laminate sheet being applied to two physical electrode elements, and further illustrating a step in the manufacturing process according to an example embodiment;

FIG. 9 is a perspective view illustrating an apparatus for manufacturing an electrode array device and a first laminate sheet having been applied to two physical electrode elements, and further illustrating a step in the manufacturing process according to an example embodiment;

FIG. 10 is a perspective view illustrating an apparatus for manufacturing an electrode array device and a first laminate sheet having been applied to two physical electrode elements, the device prepared for receiving a second laminate sheet, and further illustrating a step in the manufacturing process according to an example embodiment;

FIG. 11 is a perspective view illustrating an apparatus for manufacturing an electrode array device and a first laminate sheet having been applied to two physical electrode elements, and a portion of the first laminate sheet folded to cover electrical contacts, and further illustrating a step in the manufacturing process according to an example embodiment;

FIG. 12 is a perspective view illustrating an apparatus for manufacturing an electrode array device and a second laminate sheet being applied to two physical electrode elements, and further illustrating a step in the manufacturing process according to an example embodiment;

FIG. 13 is a perspective view illustrating an apparatus for manufacturing an electrode array device and a second laminate sheet having been applied to two physical electrode elements, and further illustrating a step in the manufacturing process according to an example embodiment;

FIG. 14 is a perspective view illustrating an apparatus for manufacturing an electrode array device and the device removed from the apparatus, and further illustrating a step in the manufacturing process according to an example embodiment; and

FIG. 15 is a perspective view illustrating a completed electrode array device according to an example embodiment.

### DETAILED DESCRIPTION

According to various embodiments, an electrode array apparatus is provided as well as a method of manufacturing the electrodes. The apparatus has an array of electrode nodes or virtual electrode pairs. However, the apparatus only has two physical electrode elements. Therefore, the virtual array of nodes created by the pair of physical electrodes only requires one pair of electrical leads and only creates one circuit. It should be understood that in other alternative embodiments, more than two physical electrode elements may be incorporated, while providing an array of virtual electrode nodes in a number that is greater than the number of physical electrode elements. For example, four physical electrode elements may provide eighteen virtual electrode nodes by incorporating the concepts described herein.

Various embodiments are also directed toward methods of manufacturing the virtual electrode node array. These methods are described after the description of an example array device.

In at least one example embodiment, a first physical electrode comprises a single, interconnected conductor having a first plurality of electrode nodes. The electrode nodes are interconnected by a common conductor element. The electrode nodes have a surface area larger than the interconnecting portion between any two of the electrode nodes. A second physical electrode is similarly constructed and comprises a second plurality of electrode nodes. The first and second plurality of electrode nodes interfit to form an array of electrode nodes.

The first and second conductors may be formed by a single metal stamping step which cuts the respective conductors out of a blank metal sheet. This is accomplished after a step of indenting, or extruding, portions of the sheet that will correspond to the electrode nodes. Preferably, the interconnections and the interfit configuration provide uniform gaps between the respective pairs of electrode nodes.

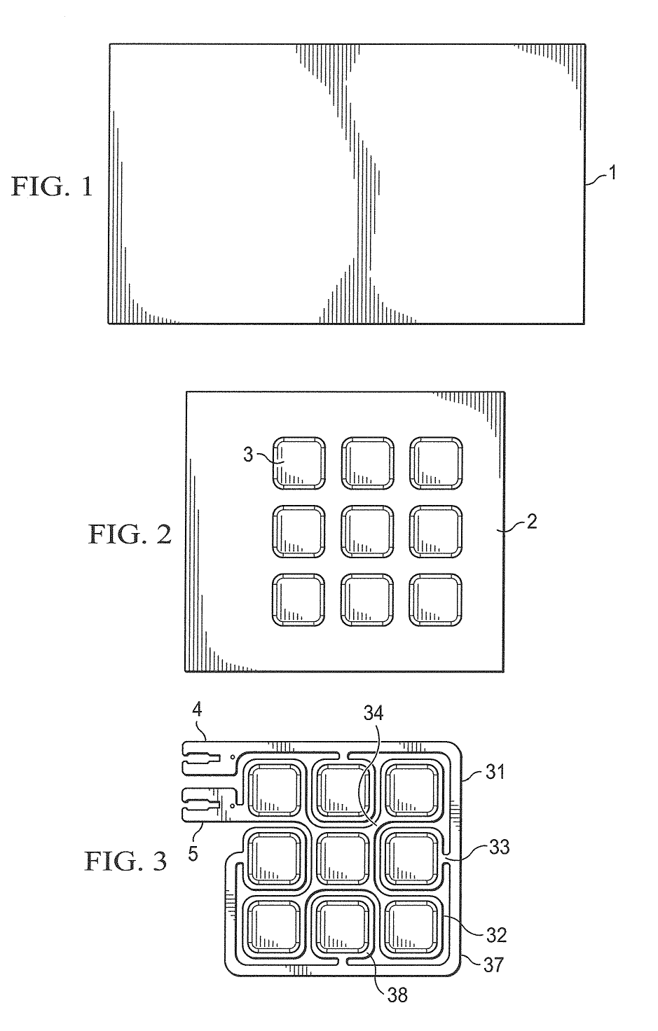

An example virtual electrode node array has a variety of components. As illustrated in FIG. 1, for instance, a stock sheet 1 of a conductive material (e.g., stainless steel) is used as a base for the physical electrode elements. While stainless steel is used for example purposes, other conductive materials may be used as desired. In one example embodiment, the stock sheet is 0.012″ thick type 304 stainless steel. Preferably the thickness is in the range of about 0.011 inches to about 0.014 inches. This is preferred for purposes of optimum metal flow.

FIG. 2 illustrates a conductive sheet 2 that has been dimpled or extruded to provide a plurality of raised protrusions 3. Raised protrusions 3, at later stages of the manufacturing process, become the electrode nodes of the electrode array device.

FIG. 3 illustrates the conductive sheet of FIG. 2 after a stamping process. The process results in two physical electrode elements. A first physical electrode element 31 has a number of raised protrusions 3. Four raised protrusions 3 are shown, but it should be understood that the approach illustrated in FIG. 3 may be used to provide additional raised protrusions. Protrusions on element 31 are continuous with element 31 and are joined with an outer, surrounding portion 37 by way of bridge portions 33. The stamping process also results in a base 38 surrounding each of the protrusions 3. Protrusions 3 on element 31 are formed in a pattern according to which the protrusions alternate with an empty space in both of the two axes of an array of protrusions. This empty space is ultimately filled by protrusions 3 of second physical electrode element 32, which is described below.

Second physical electrode element 32 has five raised protrusions 3, although it should be understood that first and second physical electrode elements 31 and 32 may each be formed to provide more or fewer raised protrusions 3. The raised protrusions 3 of element 32 are formed in a pattern according to which the protrusions alternate with an empty space in both of the two axes of an array of protrusions. This empty space is ultimately filled by protrusions 3 of first physical electrode element 32, which is described above. Protrusions 3 of element 32 are each joined to at least one neighboring protrusion 3 of element 32 by a bridge portion 34.

First and second physical electrode elements 31 and 32 are also stamped to form first and second electrical lead tabs 4 and 5. Electrical lead tabs 4 and 5 are illustrated as being patterned to receive particular electrical leads. However, it should be understood that the electrical lead tabs may have different shapes and configurations to accept different types of electrical leads. Alternatively, the tabs may be simple extensions that accommodate soldered, crimped or other connection methods. Alternatively, no lead tabs are formed and the electrical leads are coupled directly to the respective first and second physical electrode elements 31 and 32.

The first and second physical electrode elements thus formed provide first and second electrical circuits. These circuits form the basis for the completed electrode apparatus.

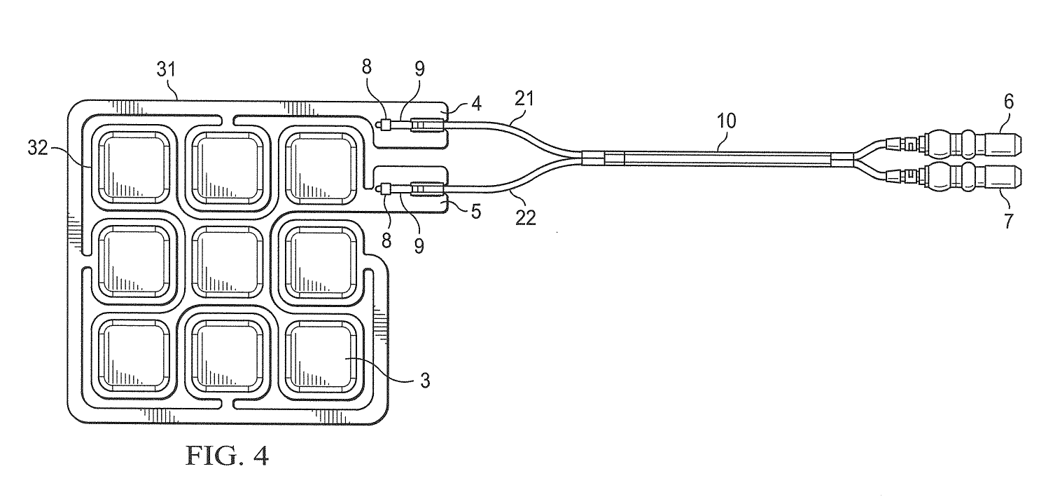

FIG. 4 illustrates the stamped conductive sheet with an electrical lead attached. Electrical lead wire assembly 10 has touch-proof molded socket connectors 6, 7 for connecting to a power source (not shown). Lead wire assembly 10 has a pair of leads 21, 22 at an end opposite socket connectors 6, 7. Lead 21 is a positive lead and lead 22 is a negative lead. However, the polarity of the leads may be reversed as desired. Each lead 21, 22 has a weld tab 8 connected to the respective lead wire with a crimped connection 9. Lead wire assembly 10 may be connected to the electrode array by resistance welding the respective weld tabs 8 to the lead tabs 4 and 5.

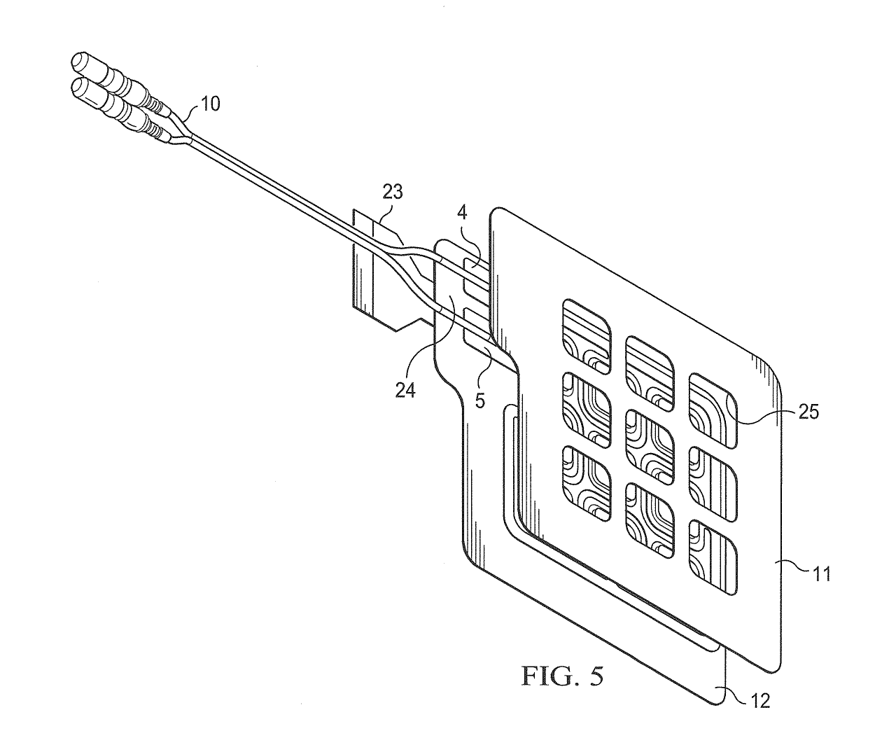

FIG. 5 illustrates the stamped conductive plates with the lead wire assembly 10 connected and being sandwiched between two laminate sheets. A first laminate sheet 11 has a number of openings 25 for receiving raised protrusions 3. First laminate sheet 11 is applied to the stamped conductive sheet on the same side as the raised protrusions 3. A second laminate sheet 12 has a lead connector protective pad 23. Second laminate sheet 12 is applied to the side of the conductive sheet opposite the raised protrusions 3. Preferably, second laminate sheet 12 is applied first. Then the protective pad 23 is folded over between the electrical leads and disposed on area 24 of second laminate sheet 12 such that wing portions of the pad cover the respective electrical lead connections. Then, first laminate sheet 11 is applied. When first laminate sheet 11 is applied, protrusions 3 are disposed through openings 25 such that the backing of first laminate sheet 11 immediately surrounding respective openings 25 seats and seals against the bases 38 of the respective raised protrusions 3.

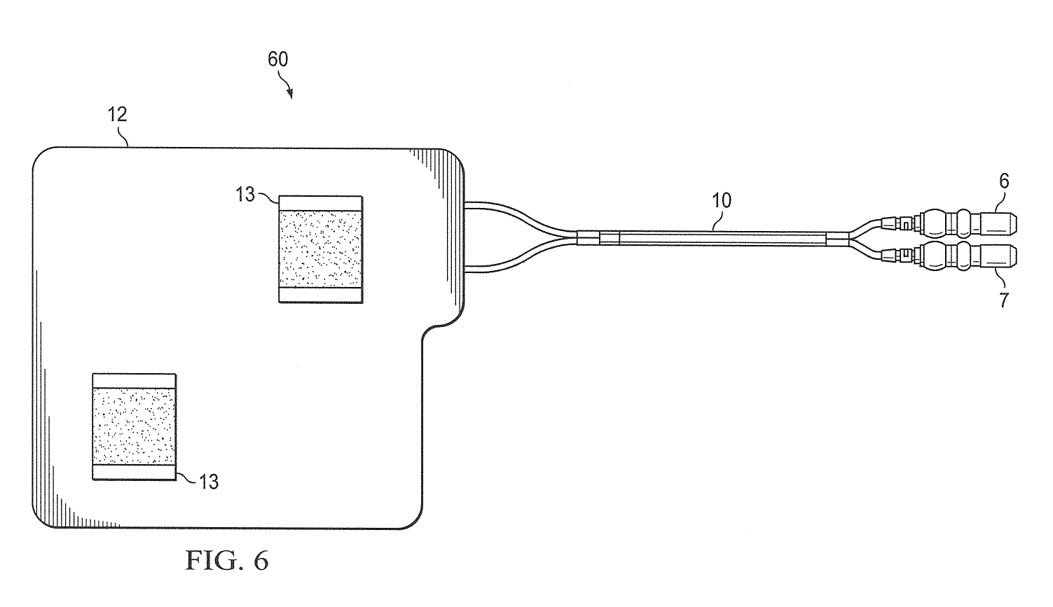

FIG. 6 illustrates a completed electrode apparatus from the side opposite that shown generally in FIG. 5. Apparatus 60 is preferably constructed according to the description herein. However, it should be understood that variations may be made in the manufacturing process and that the resulting apparatus may be either the same or somewhat different. Minor changes in either the manufacturing process or the apparatus itself are considered to be within the scope of this disclosure.

Apparatus 60 is illustrated from the view of second laminate sheet 12. A pair of Velcro® connectors 13 are provided for fastening to accessories (not shown) used in a neurostimulation procedure. It should be understood that the connectors may be greater or fewer in number, may have different placements, and may be of different types. The side viewed in FIG. 6 may be referred to as the top side of the apparatus, while the opposite side would be applied to the target area (e.g., the skin of a human patient).

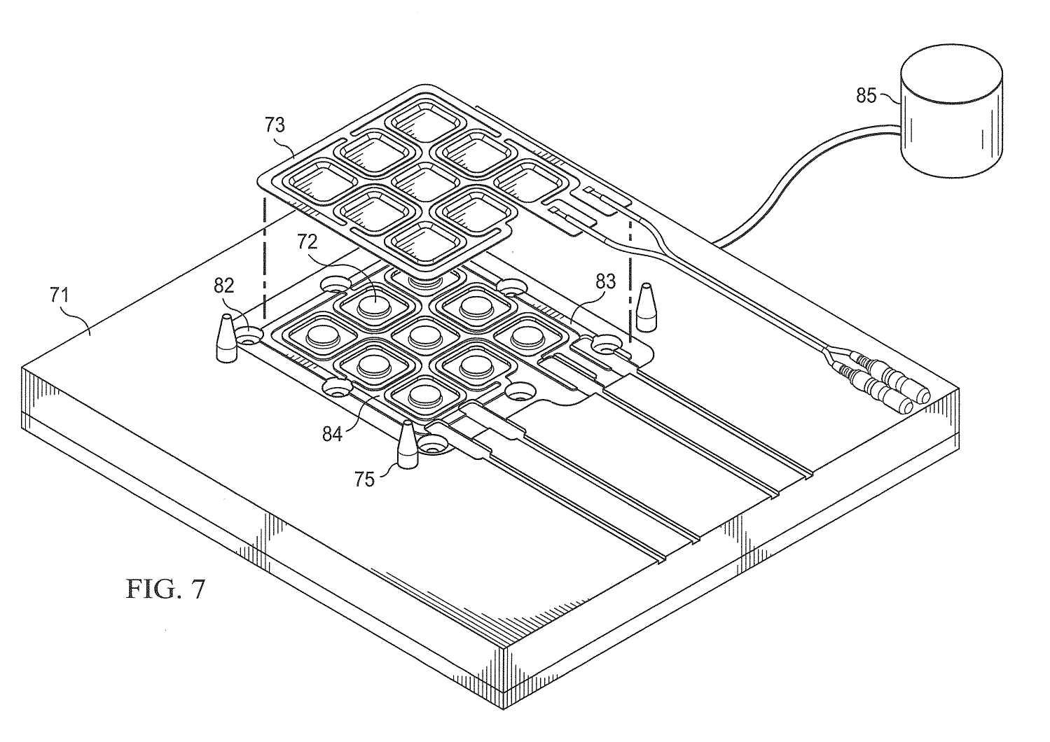

FIG. 7 illustrates an apparatus for manufacturing a neurostimulation device according to an example embodiment. In at least one embodiment, manufacturing apparatus 71 is a vacuum device which has formed therein a number of passageways (not expressly shown). The passageways are interconnected and/or connected to a vacuum pump 85. For simplicity, pump 85 is not shown in other figures illustrating the manufacturing process. One or more of the internal passageways terminates in a plurality of holes 82 at an upper surface of apparatus 71. One or more of the holes 82 are interconnected with vacuum paths 83. When a vacuum is applied to apparatus 71, air is drawn into holes 82 in a manner to create a suction on holes 82 and vacuum paths 83 in order to hold an object adjacent to one or more of the holes 82 and/or vacuum paths 83. Apparatus 71 also includes a plurality of suction cups 72. Suction cups 72 are operable to hold an object (preferably with a flat surface) against suctions cups 72. Apparatus 71 also includes a plurality of tapered alignment pins, which are operable to mate with holes in an object and align the object with respect to vacuum holes 82, vacuum paths 83 and suction cups 72. Apparatus 71 includes a receiving tray 84 for receiving an object. It is preferable that receiving tray 84 be configured to have a surface that matches with a surface of an object that will be placed in receiving tray as described below. However, it should be understood that the configuration of the apparatus 71 illustrated in FIG. 7 is an example only, and the various elements of apparatus 71 may be altered or otherwise reconfigured to mate with different objects, to provide different alignment features, and to provided different vacuum and suction characteristics. In at least one alternative embodiment, the vacuum created by pump 85 also creates a vacuum by drawing air through one or more holes in suction cups 72.

FIG. 7 also illustrates a stamped conductive plate 73 having connected electrical leads, such as may be formed according to one or more example embodiments as already described. FIG. 7 further illustrates a step in a process for manufacturing a neurostimulation device. The stamped conductive plate 73 is positioned within apparatus 71, such that the raised protrusions of the stamped conductive plate are facing downward to seat against suction cups 72. Preferably, there is a suction cup 72 for each of the raised protrusions and it is also preferable that each respective suction cup 72 be positioned generally in the center of the surface of the respective raised protrusion which stamped conductive plate 73 is positioned in receiving tray 84. However, alterations to this configuration may be made as desired and are within the scope of this disclosure. Once stamped conductive plate 73 is thus positioned, pressure is applied to stamped conductive plate 73 in order to assist suction cups 72 in creating a suction force to hold the respective surfaces of the raised protrusions.

In another step, vacuum pump 85 is activated to create a vacuum through one or more of the internal passageways in apparatus 71, and/or through one or more holes (in certain embodiments) in suction cups 72. Vacuum at multiple suction cups 72 provides a means to hold in a steady and precise alignment all 9 protrusions in stamped conductive place 73 in receiving tray 84. In at least one example embodiment, the vacuum pressure applied is in the range of 15″ Hg to 25″ Hg. More preferably, the range is about 20″ Hg to 22″ Hg. Even more preferably, the range is about 26 liters per minute.

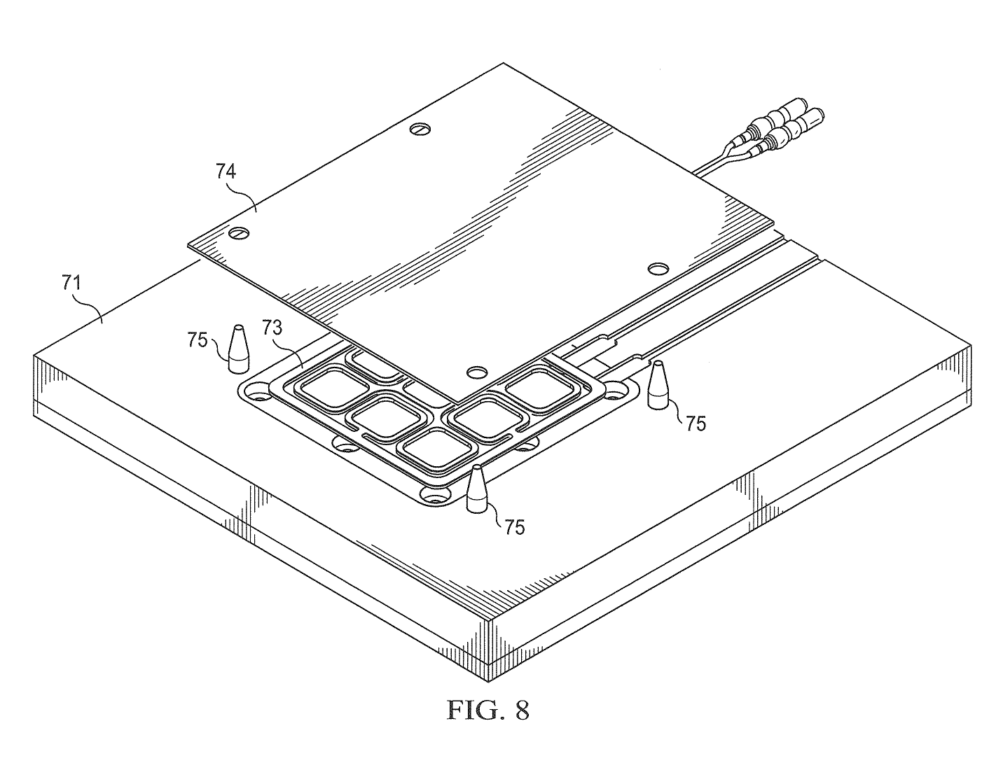

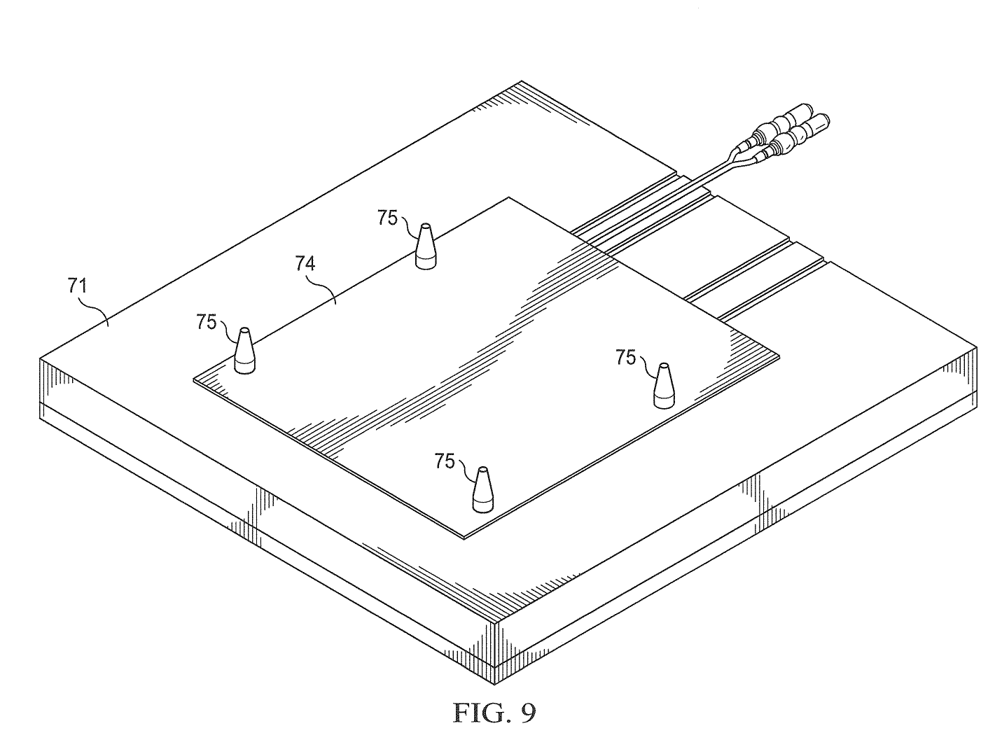

FIG. 8 illustrates a stamped conductive plate 73 firmly seated in receiving tray 84 of apparatus 71 and held in place by vacuum at multiple suction cups 72. Also illustrated is the application of a first laminate 74 to stamped conductive plate 73. First laminate 74 preferably has a plurality of alignment holes to match the tapered alignment pins 75 of apparatus 71. First laminate 74 is positioned such that the alignment pins 75 are received through the laminate's alignment holes. This guides first laminate 75 into a position on top of what may be viewed as a back surface of stamped conductive plate 73. Preferably, first laminate 74 has an adhesive surface, which bonds to the surface of stamped conductive plate 73. Pressure may be applied to first laminate 74 to assist in the bonding process. Additionally, vacuum pressure provided as already described may further assist in the bonding process.

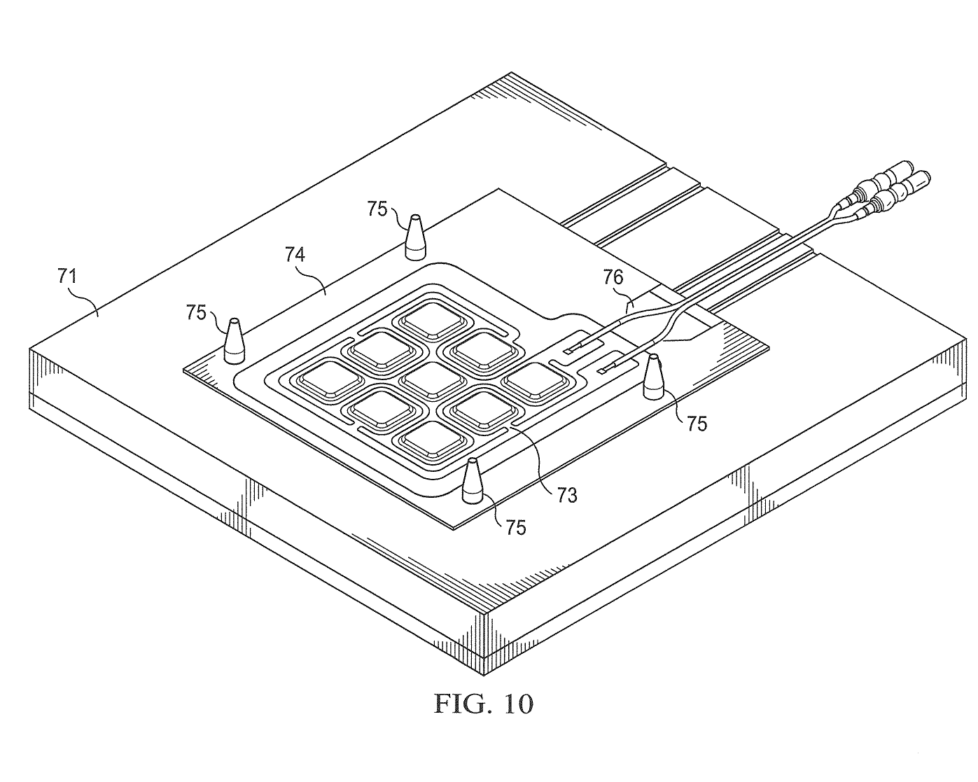

FIG. 9 illustrates the first laminate firmly secured to the surface of the stamped conductive plate 73. If there is a liner on first laminate 74, such as a protective sheet for example, it may be removed. The vacuum pump 85 may now be turned off.

The partially-completed neurostimulation device may be removed from apparatus 71 and flipped over 180 degrees such that the raised protrusions are now facing upward and away from the receiving tray 84.

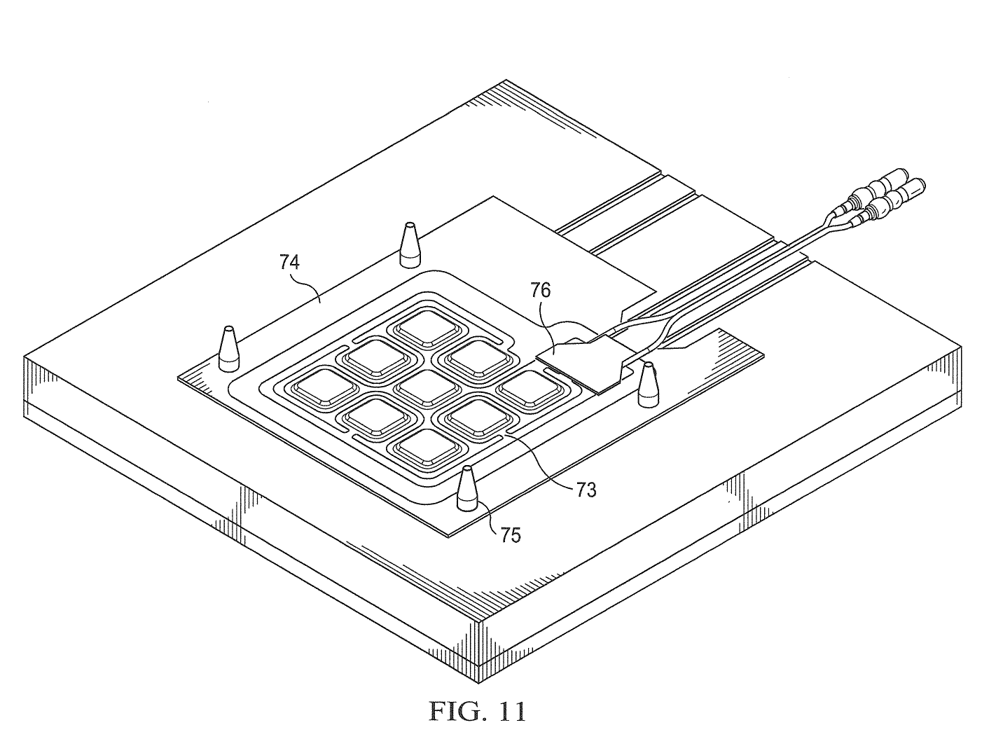

As illustrated in FIG. 10, the flipped-over assembly is now re-seated in the receiving tray 84, preferably by aligning the alignment holes in first laminate 74 with the tapered alignment pins 75 of apparatus 71. Although it is not required, a vacuum may be re-applied as previously described.

FIG. 11 illustrates an aspect of certain embodiments in which first laminate 74 has a lead protector flap 76. If a liner is provided on this side of the first laminate 74, the liner portion on flap 76 may be removed. Flap 76 is folded over between the two leads. Flap 76 is positioned to cover the area at which the leads are connected to lead tabs on stamped conductive plate 73.

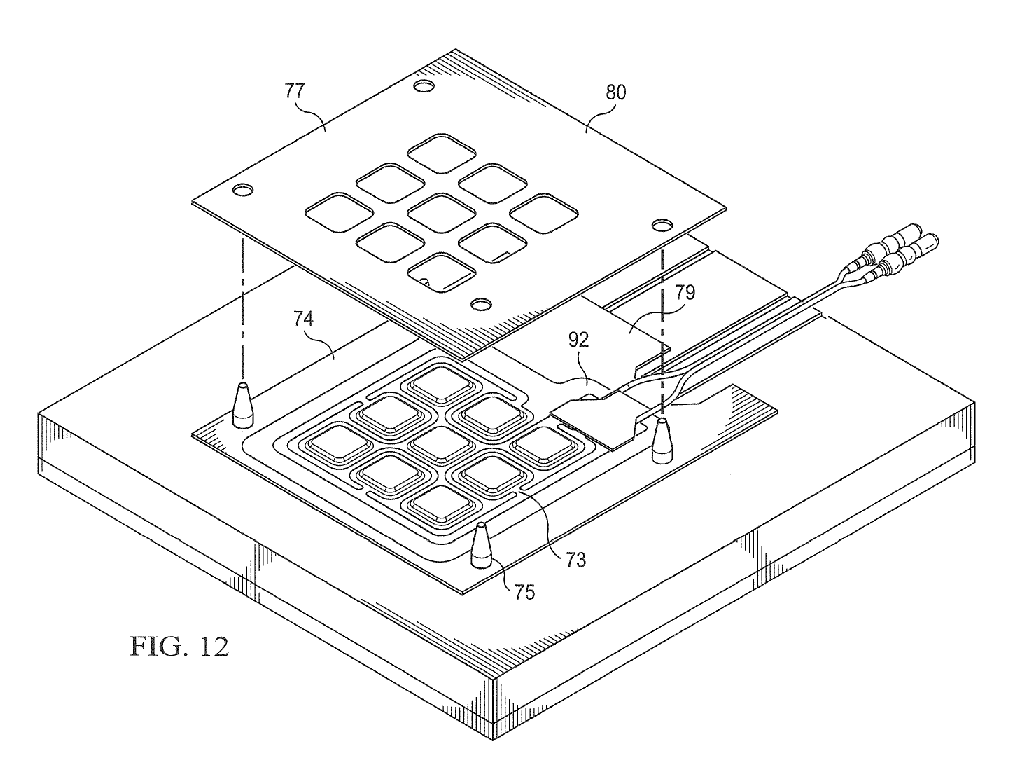

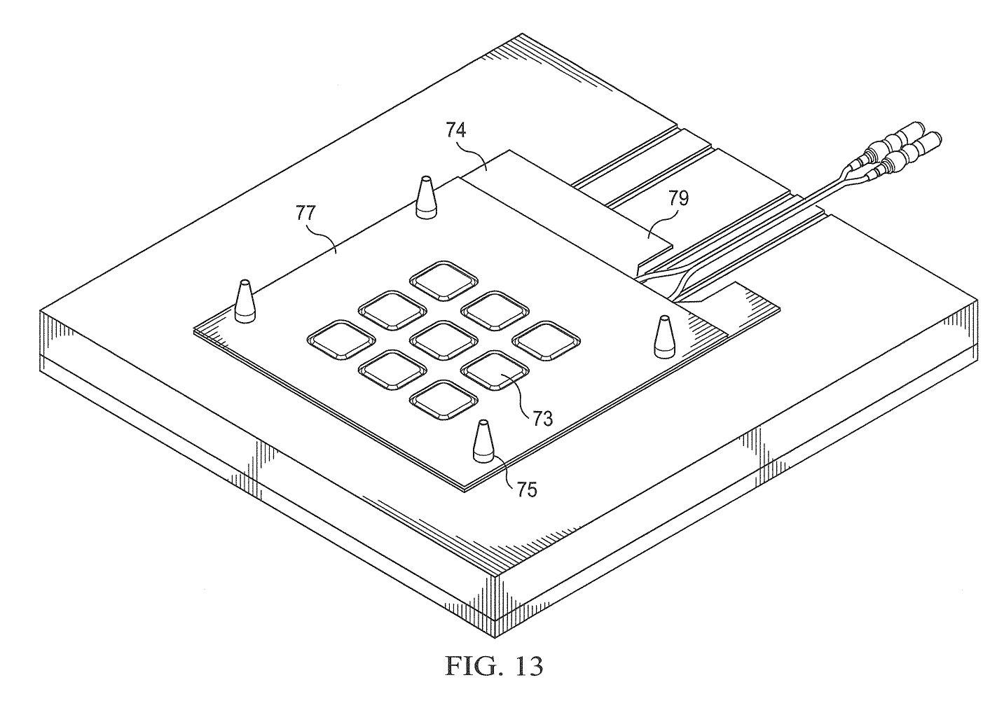

FIG. 12 illustrates a second laminate 77 being applied to the upper surface of the assembly. If there is a paper liner covering the adhesive surface, it may be removed before applying second laminate to the assembly. Preferably, second laminate 77 has edges that are coextensive with the perimeter edges of first laminate 74 (except for electrical lead protector flap 76). Second laminate 77 preferably has a plurality of alignment holes, similar to first laminate 74 for assisting in the alignment of second laminate 77 during its application to the assembly. Second laminate 77 also has a plurality of holes configured to receive the raised protrusions as described elsewhere herein.

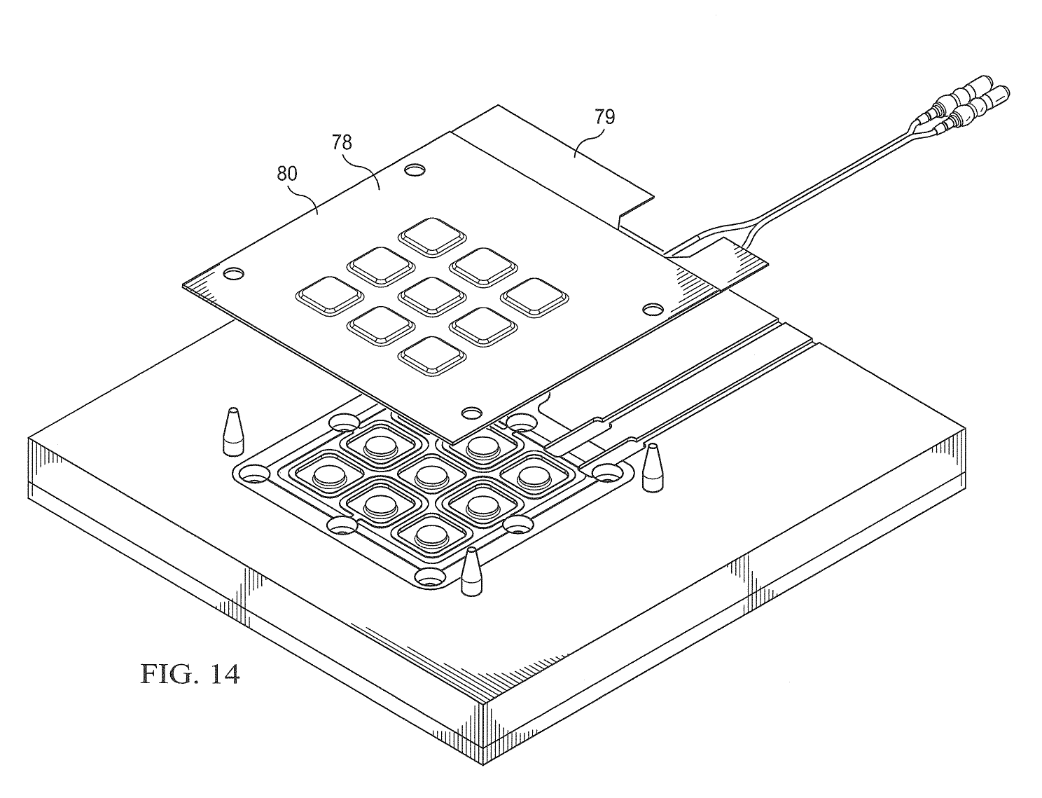

FIG. 13 illustrates the assembly with second laminate 77 firmly affixed. Preferably second laminate 77 is affixed to the assembly as similarly described in connection with the application of first laminate 74. If the vacuum has been applied, it may now be turned off.

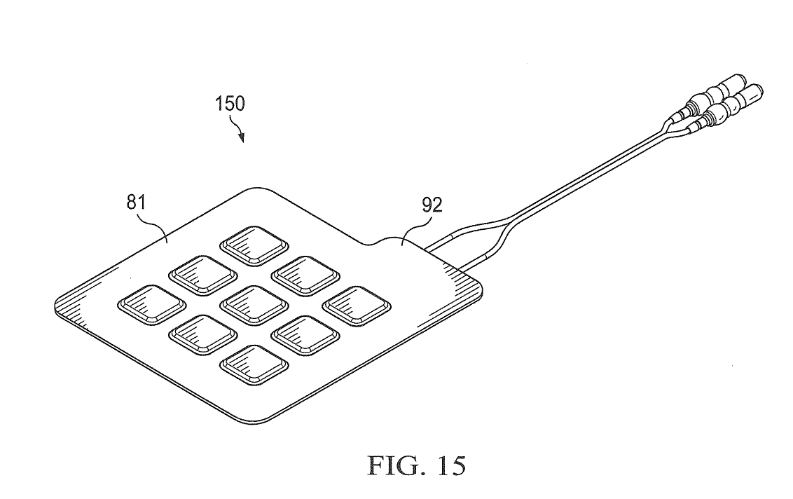

FIG. 14 illustrates the partially-completed neurostimulation assembly removed from apparatus 71. As can be seen in FIGS. 12 and 13, first laminate 74 has a carrier portion 79. Similarly, second laminate 77 has a carrier portion 80. Carrier portions 79, 80 may be removed from their respective laminates. This leaves function portions 81 of the first and second laminates 74, 77. FIG. 15 illustrates the completed neurostimulation device 150. Functioning laminate portions 81 of the completed device provide a lead wire extension area 92 which extends away from the electrode node array of the device.

It should be understood that the configuration of the various components of device 150, as well as the steps in the manufacturing process, may be altered while still falling within the scope of this disclosure and the claims that follow.

For example, it is not critical to have the electrical lead wire extension area 92. The polarity of the leads may be reversed. Different laminate structures may be utilized to hold the two physical electrode elements in place. More or fewer vacuum holes and alignment holes may be provided. Other adjustments and modifications may be made as desired or deemed to be better for the manufacturing process, the device or its application, efficiency, etc.

It should be understood that the various figures and their description illustrate example embodiments of the apparatus and various aspects of the apparatus may be added, eliminated, and/or substituted for those shown. Such modifications may be made as is desired, suitable, and/or advantageous for performing the functionality described herein. Such modifications are within the scope of the invention.

Numerous other changes, substitutions, variations, alterations, and modifications may be ascertained by those skilled in the art and it is intended that the present invention encompass all such changes, substitutions, variations, alterations and modifications as falling within the spirit and scope of this description.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An electrode node array apparatus, comprising:
a first physical electrode element having a first plurality of electrode nodes formed therein interconnected by a common first conductor; and
a second physical electrode element having a second plurality of electrode nodes formed therein interconnected by a common second conductor;
the first and second conductors being arranged to interfit the first and second pluralities of electrode nodes to form an array of electrode nodes.

2. The apparatus of claim 1, further comprising:
a first electrical lead coupled to the first conductor; and
a second electrical lead coupled to the second conductor, the first and second electrical leads adapted to be connected to a source to establish a first polarity for the first conductor and a second polarity for the second conductor, wherein when the source is activated adjacent pairs of electrode nodes within the electrode node array have opposite polarities.

3. The apparatus of claim 1, wherein the number of electrode nodes is greater than the number of physical electrode elements.

4. The apparatus of claim 1, wherein there are only a first and second conductor.

5. The apparatus of claim 1, wherein the array of electrode nodes comprises a square array having the same number of electrode nodes in each of two axes.

6. The apparatus of claim 1, wherein the electrode nodes comprise raised protrusions stamped from a stock sheet of conductive material.

7. The apparatus of claim 1, wherein the first and second conductors comprise portions of a stock sheet of conductive material and are formed simultaneously during a stamping process.

8. The apparatus of claim 1, wherein the first conductor extends along a majority of the perimeter of the device and is connected to alternating ones of the plurality of electrode nodes by a plurality of conductive bridge elements.

9. The apparatus of claim 1, wherein a plurality of electrode nodes associated with the second conductor is encompassed by a perimeter defined by a portion of the first conductor.

10. A method of making an electrode node array, comprising:
providing a conductive sheet;
forming a plurality of raised protrusions in the conductive sheet to correspond to a plurality of electrode nodes;
stamping a first conductor from the conductive sheet, the first conductor comprising a first set of the plurality of the raised protrusions interconnected by a common first conductor element;
stamping a second conductor from the conductive sheet, the second conductor comprising a second set of the plurality of raised protrusions interconnected by a common second conductor element; and
interfitting the first and second conductors, wherein the first and second sets of raised protrusions are configured in an array of electrode nodes.

11. The method of claim 10, further comprising connecting a first electrical lead having a first polarity to the first conductor and connecting a second electrical lead having a second polarity to the second conductor, wherein any pair of adjacent electrode nodes has opposite polarities when the first and second electrical leads are connected to a source.

12. The method of claim 10, further comprising:
applying a first laminate to a first side of the stamped first and second conductors; and
applying a second laminate to a second side of the stamped first and second conductors, wherein the first and second laminates cooperate to hold the first conductor in alignment with the second conductor.

13. The method of claim 12, wherein at least one of the first and second laminates comprises a lead protection tab, and the method further comprising folding the lead protection tab over to cover at least a portion of the lead connections.

14. An apparatus for manufacturing an electrode node array device, the apparatus comprising:
a receiving tray having defined therein a plurality of recesses to correspond with a plurality of electrode nodes of the array device; and
one or more vacuum passages having a first end connectable to a vacuum source and a second end terminating at a hole at a surface of the apparatus, the hole operable to interact with at least a portion of an array device positioned on the apparatus to hold at least a portion of the array device against the apparatus.

15. The apparatus of claim 14, further comprising at least one suction cup disposed in at least one of the plurality of recesses, the at least one suction cup operable to interact with a surface of at least one of the plurality of electrode nodes of the array device to hold the surface adjacent the apparatus.

16. The apparatus of claim 14, further comprising at least one alignment pin operable to receive a corresponding at least one alignment hole of a laminate associated with the array device.
